(19) United States
(12) Patent Application Publication
(10) Pub. No.: US 2026/0077419 A1
(43) Pub. Date: Mar. 19, 2026

(54) WELDING TEACHING SYSTEM, GENERATION METHOD FOR WELDING PROGRAM, AND NON-TRANSITORY COMPUTER READABLE MEDIUM STORING GENERATION PROGRAM FOR WELDING PROGRAM

(71) Applicant: Panasonic Intellectual Property Management Co., Ltd., Osaka (JP)

(72) Inventors: Masaya HIRAYAMA, Osaka (JP); Akimasa UCHIKATA, Osaka (JP)

(21) Appl. No.: 19/395,365

(22) Filed: Nov. 20, 2025

Related U.S. Application Data
(63) Continuation of application No. PCT/JP2024/030172, filed on Aug. 26, 2024.

(30) Foreign Application Priority Data
Nov. 15, 2023 (JP) 2023-194667

(51) Int. Cl. B23K 9/095; B23K 9/127; B25J 9/16; B25J 11/00

(52) U.S. Cl. CPC B23K 9/0953; B23K 9/127; B25J 9/1656; B25J 11/005

(57) ABSTRACT

A welding system includes a teaching device that receives a teaching operation and a terminal device. The teaching device acquires a teaching point including a teaching position for teaching a position of a welding torch and a teaching posture for teaching a posture of the welding torch. The terminal device calculates a reference coordinate system related to the posture of the welding torch at the teaching position based on the teaching position of a plurality of acquired teaching points and information related to a workpiece, corrects the teaching posture to a set posture set in advance based on the teaching posture with respect to the reference coordinate system, and generates and outputs a welding teaching program for the welding robot based on the teaching positions of the plurality of teaching points and the teaching posture.

### CROSS-REFERENCE TO RELATED APPLICATIONS

The present application is a continuation application of PCT/JP2024/030172 that claims priority to Japanese Patent Application No. 2023-194667 filed on Nov. 15, 2023, the entire content of which is incorporated herein by reference.

### TECHNICAL FIELD

The present disclosure relates to a welding teaching system, a generation method for a welding program, and a generation program for the welding program, and a non-transitory computer readable medium storing the generation program for the welding program.

### BACKGROUND ART

JPH08-328632A discloses a method for simulating a robot operation for offline teaching of a robot to perform a required work on a workpiece. According to the method for simulating a robot operation, models of a robot, a workpiece, and a peripheral device are set on a robot simulator provided with a graphic display that displays the models, a program for causing the robot to operate is created, and then an operation of the robot caused by the created program is verified by simulation on the robot simulator. According to the method for simulating a robot operation, in the verification, for each teaching point set on the models, a range allowed at each teaching point of the actual workpiece and the robot is given as a positional deviation allowable area of each teaching point, and then when the robot is caused to operate using the teaching points, it is verified whether the positional deviation allowable area is included in a movable range of the robot, and whether other components interfere with the positional deviation allowable area.

### SUMMARY OF INVENTION

The present disclosure provides a welding teaching system, a generation method for a welding program, and a generation program for the welding program that correct a taught posture to a posture more suitable for actual welding.

The present disclosure provides a welding teaching system, including: a teaching device that is operated by an operator and receives a teaching operation for teaching an operation of a welding torch provided in a welding robot; and a terminal device capable of communicating with the teaching device. The teaching device is configured to: acquire, from the teaching operation by the operator, a teaching point including a teaching position for teaching a position of the welding torch that performs welding and a teaching posture for teaching a posture of the welding torch, and transmit the teaching point to the terminal device. The terminal device is configured to: calculate, based on the teaching position of each of a plurality of the acquired teaching points and information related to a workpiece subjected to the welding, a reference coordinate system related to the posture of the welding torch at the teaching position; correct the teaching posture to a set posture set in advance when determining that correction for the teaching posture is necessary based on the teaching posture with respect to the reference coordinate system; and generate and output a welding teaching program of the welding robot for welding the workpiece based on the teaching position and the teaching posture of each of the plurality of teaching points.

The present disclosure provides a generation method for a welding program to be performed by a system including a teaching device that is operated by an operator and receives a teaching operation for teaching an operation of a welding torch provided in a welding robot, and a terminal device capable of communicating with the teaching device. The generation method for the welding program includes: acquiring, from the teaching operation by the operator, a teaching point including a teaching position for teaching a position of the welding torch that performs welding and a teaching posture for teaching a posture of the welding torch; calculating, based on the teaching position of each of a plurality of the acquired teaching points and information related to a workpiece subjected to the welding, a reference coordinate system related to the posture of the welding torch at the teaching position; correcting the teaching posture to a set posture set in advance when determining that correction for the teaching posture is necessary based on the teaching posture with respect to the reference coordinate system; and generating and outputting a welding teaching program of the welding robot for welding the workpiece based on the teaching position and the teaching posture of each of the plurality of teaching points.

The present disclosure provides a non-transitory computer readable medium storing a generation program for a welding program that causes a computer to execute a process, the computer being capable of communicating with a teaching device that is operated by an operator and receives a teaching operation for teaching an operation of a welding torch provided in a welding robot. The process includes: a step of acquiring, from the teaching operation by the operator, a teaching point including a teaching position for teaching a position of the welding torch that performs welding and a teaching posture for teaching a posture of the welding torch; a step of calculating, based on the teaching position of each of a plurality of the acquired teaching points and information related to a workpiece subjected to the welding, a reference coordinate system related to the posture of the welding torch at the teaching position; a step of correcting the teaching posture to a set posture set in advance when determining that correction for the teaching posture is necessary based on the teaching posture with respect to the reference coordinate system; and a step of generating and outputting a welding teaching program of the welding robot for welding the workpiece based on the teaching position and the teaching posture of each of the plurality of teaching points.

According to the present disclosure, a taught posture can be corrected to a posture more suitable for actual welding.

### BRIEF DESCRIPTION OF DRAWINGS

FIG. 1 shows an example of a welding teaching system according to an embodiment;

FIG. 2 shows an example of a teaching screen;

FIG. 3 shows a welding teaching example of a linear welding line;

FIG. 4 shows a correction example for a tilt angle;

FIG. 5 shows a correction example for a forward and backward angle;

FIG. 6 shows a correction example for a twisting angle;

FIG. 7 shows a welding teaching example of an arc-shaped welding line;

FIG. 8 is a flowchart showing an operation procedure example of a terminal device according to an embodiment;

FIG. 9 is a flowchart showing a correction procedure example of a teaching point of the terminal device according to the embodiment; and

FIG. 10 is a flowchart showing a correction procedure example of a teaching point of the terminal device according to the embodiment.

### DESCRIPTION OF EMBODIMENTS

### Background of Present Disclosure

In recent years, there has been a teaching method of teaching an operation during welding using a virtual reality (VR) device, in which an operator directly teaches a teaching point, and therefore, as compared with a case where a general offline teaching system such as a teach pendant is used, a time required for teaching a teaching point can be shortened. However, in such a teaching method for a welding operation, since teaching is performed by a manual operation by an operator, a posture of a welding torch may be different at each of a plurality of teaching points taught for welding one welding line. Therefore, the operator needs to correct the posture of the welding torch using an offline teaching system or the like in a welding teaching program generated based on the teaching point, which is very troublesome.

Therefore, in the following embodiments, a welding teaching system, a generation method for a welding program, and a generation program for the welding program that correct a taught posture to a posture more suitable for welding will be described.

Hereinafter, the embodiments specifically disclosing a welding teaching system, a generation method for a welding program, and a generation program for the welding program according to the present disclosure will be described in detail with reference to the drawings as appropriate. However, unnecessarily detailed description may be omitted. For example, the detailed descriptions of well-known matters and the redundant description of substantially the same configuration may be omitted. This is to avoid unnecessary redundancy of the following description and facilitate understanding of those skilled in the art. The accompanying drawings and the following descriptions are provided for those skilled in the art to fully understand the present disclosure and are not intended to limit the subject matters described in the claims.

### <Outline of Welding System>

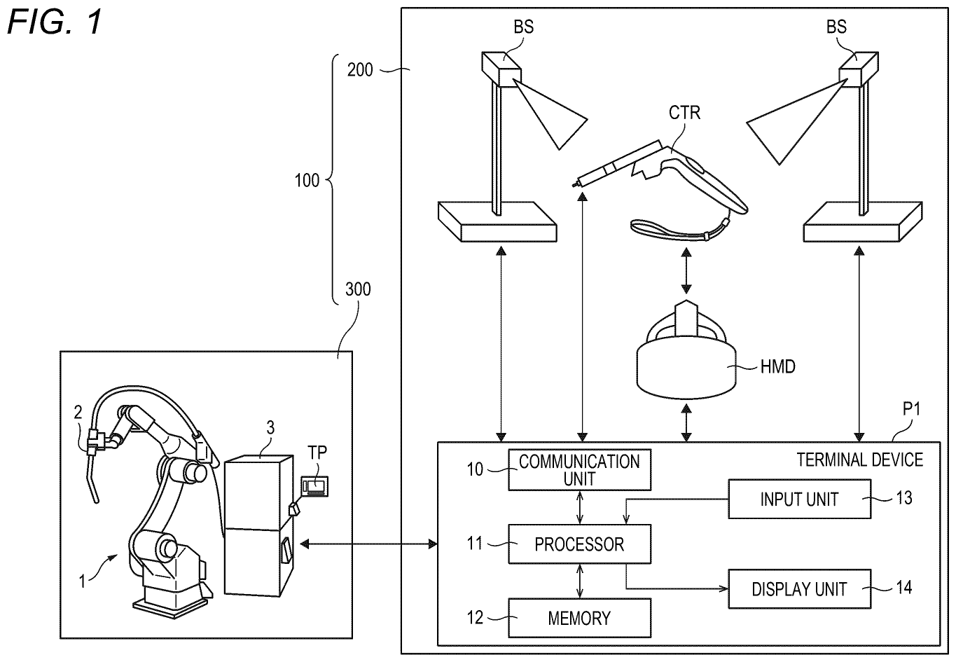

First, a welding system 100 according to an embodiment will be described with reference to FIG. 1. FIG. 1 shows an example of the welding system 100 according to the embodiment. It should be noted that configurations of the welding system 100, a welding teaching system 200, and a welding robot system 300 shown in FIG. 1 are merely examples, and the present disclosure is not limited thereto.

The welding system 100 includes the welding teaching system 200 for teaching a welding operation to a welding robot 1, and the welding robot system 300 for the welding robot 1 to execute the welding operation.

The welding teaching system 200 generates a welding teaching program for causing the welding robot 1 to execute the welding operation based on a teaching point taught by an operator who teaches the welding operation, and transmits the welding teaching program to the welding robot system 300. The welding teaching system 200 includes at least one base station BS, a controller CTR, a head-mounted display HMD, and a terminal device P1.

The base station BS is connected to the controller CTR and the terminal device P1 in a way of being capable of data communication. The base station BS emits infrared light toward the controller CTR in order to detect position information and posture information of the controller CTR at an operation position of the controller CTR.

The controller CTR is connected to the head-mounted display HMD, the base station BS, and the terminal device P1 in a way of being capable of data communication. The controller CTR includes at least one operation button (not shown) capable of receiving an operation from the operator, and receives a teaching operation (input operation) of a teaching point based on a pressing operation on the operation button (not shown). The operator grasps and operates the controller CTR as if the controller CTR were a welding torch 2 while viewing a teaching screen, which will be described later, thereby teaching a teaching point on an actual workpiece Wk. It should be noted that the controller CTR may include a distal end having the same shape as the welding torch 2 so that the operator can intuitively teach a teaching point through which the welding torch 2 of the welding robot 1 passes using the controller CTR.

The controller CTR includes at least one light receiving unit (not shown) capable of receiving the infrared light emitted from the base station BS. The controller CTR calculates the position information of the distal end of the controller CTR and the posture information of the controller CTR at a timing when the operation button is pressed, that is, at a teaching timing of the teaching point, based on an arrival time, angle information, or the like of the infrared light received by the light receiving unit (not shown). The controller CTR transmits the calculated position information of the distal end of the controller CTR and the calculated posture information of the controller CTR to the terminal device P1.

It should be noted that the position information of the distal end of the controller CTR described here corresponds to information on the teaching position for welding. The posture information of the controller CTR corresponds to information on a posture of the welding torch 2 at the teaching position for welding, and includes information on each of a tilt angle, a forward and backward angle, and a twisting angle of the welding torch 2 with respect to an XYZ coordinate system set for the workpiece Wk. The tilt angle, the forward and backward angle, and the twisting angle will be described later.

It should be noted that the processing of calculating the position information of the distal end of the controller CTR or the posture information of the controller CTR may be executed by the head-mounted display HMD or the terminal device P1.

The head-mounted display HMD is connected to the controller CTR and the terminal device P1 in a way of being capable of data communication, and functions as a device for relaying data in communication. It should be noted that the head-mounted display HMD is not essential and may be omitted, and in such a case, the controller CTR and the terminal device P1 directly perform data communication. It should be noted that the head-mounted display HMD may not be mountable on the head of the operator, and may be installed at any place so as to enable data communication between the controller CTR and the terminal device P1.

The terminal device P1 is connected to the base station BS, the controller CTR, the head-mounted display HMD, and a robot control device 3 in a way of being capable of data communication. The terminal device P1 generates the welding teaching program for causing the welding robot 1 to execute welding based on the position information and the posture information of the teaching point taught by the controller CTR. The terminal device P1 includes a communication unit 10, a processor 11, a memory 12, an input unit 13, and a display unit 14.

The communication unit 10 is connected to the base station BS, the controller CTR, the head-mounted display HMD, and the robot control device 3 in a way of be capable of wireless communication or wired communication, and executes transmission and reception of data. The communication unit 10 outputs various kinds of data transmitted from the base station BS, the controller CTR, the head-mounted display HMD, and the robot control device 3 to the processor 11. The communication unit 10 transmits various kinds of data output from the processor 11 to a corresponding device (the base station BS, the controller CTR, the head-mounted display HMD, or the robot control device 3). The wireless communication referred to here is communication via a wireless local area network (LAN) such as Wi-Fi (registered trademark).

The processor 11 is implemented by using, for example, a central processing unit (CPU) or a field programmable gate array (FPGA), and executes various kinds of processing and control in cooperation with the memory 12. Specifically, the processor 11 implements various functions for generating the welding teaching program by referring to a program and data stored in the memory 12 and executing the program.

The memory 12 includes, for example, a random access memory (hereinafter, referred to as a “RAM”) as a work memory used when each processing of the processor 11 is executed, and a read only memory (hereinafter, referred to as a “ROM”) storing a program and data defining each operation of the processor 11. The RAM temporarily stores data or information generated or acquired by the processor 11. The program that defines the operation of the processor 11 is written in the ROM. The memory 12 may record various programs or various kinds of data necessary for generating the welding teaching program. For example, the memory 12 records information on the workpiece Wk to be welded, information on a production facility of the workpiece Wk such as the welding robot 1, the welding torch 2, or a jig, correction information related to the posture information, and the like.

It should be noted that the correction information mentioned here is information for performing correction processing on the tilt angle, the forward and backward angle, or the twisting angle of the controller CTR acquired as the posture information to a preset optimal posture (angle), and is set by the operator in advance. The correction information includes information on an allowable range that is a condition for determining whether to correct the tilt angle, the forward and backward angle, or the twisting angle of the controller CTR, and information on the optimal posture (optimal angle) of the tilt angle, the forward and backward angle, or the twisting angle of the controller CTR after correction. It should be noted that the correction information may be set to any one or all of the tilt angle, the forward and backward angle, and the twisting angle.

The input unit 13 is a user interface capable of receiving an input operation from an operator, and is implemented by, for example, a keyboard, a mouse, a touch panel, or the like. It should be noted that the operator who operates the input unit 13 may not be the same person as the operator who operates the controller CTR. The input unit 13 converts a content of the received input operation into an electric signal and transmits the electric signal to the processor 11. It should be noted that when the input unit 13 is implemented by a touch panel, the input unit 13 may be integrated with the display unit 14.

The display unit 14 is implemented using, for example, a liquid crystal display (LCD) or an organic electroluminescence (EL). The display unit 14 displays image data output from the processor 11. It should be noted that the image data referred to here is, for example, a teaching image generated based on a teaching result by the operator. It should be noted that the teaching image will be described later.

The welding robot system 300 is configured to drive the welding robot 1 capable of performing welding, and drives the welding robot 1 based on the welding teaching program transmitted from the terminal device P1. The welding robot system 300 includes the welding robot 1, the robot control device 3, and a teach pendant TP. It should be noted that the teach pendant TP is not an essential component and may be omitted.

The welding robot 1 is connected to the robot control device 3 in a way of being capable of data communication. The welding robot 1 includes an articulated robot arm, and the welding torch 2 as an end effector at a distal end of the robot arm. Under control of the corresponding robot control device 3, the welding robot 1 drives the welding torch 2 to perform a welding operation based on the welding teaching program.

The robot control device 3 is connected to the welding robot 1, the teach pendant TP, and the terminal device P1 in a way of being capable of data communication. The robot control device 3 controls the welding robot 1 to execute the welding operation based on the welding teaching program transmitted from the terminal device P1. It should be noted that the robot control device 3 may read and transmit a welding operation program based on a control command requesting reading of the welding operation program from the teach pendant TP. The robot control device 3 may acquire and record a corrected or changed welding operation program from the teach pendant TP.

The teach pendant TP is connected to the robot control device 3 in a way of being capable of transmitting and receiving data. The teach pendant TP executes correction or change of the welding teaching program recorded in the robot control device 3 and transmits the welding teaching program to the robot control device 3.

### <Teaching Example of Linear Welding Line>

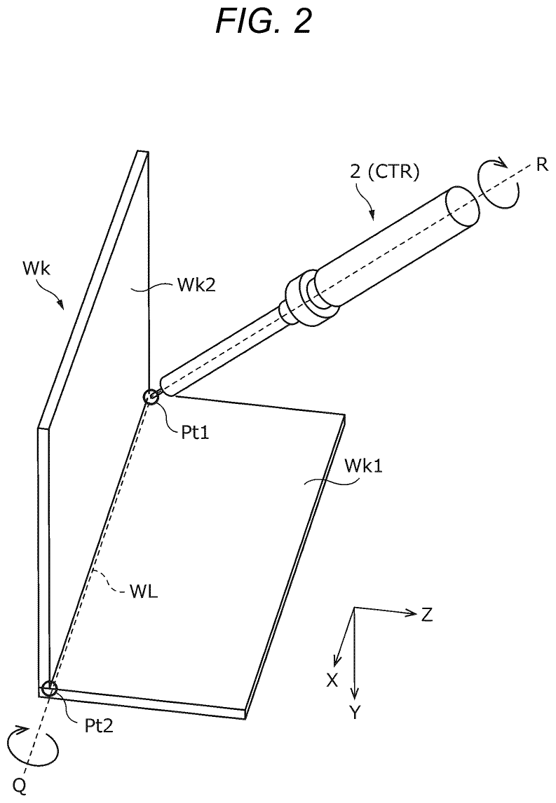

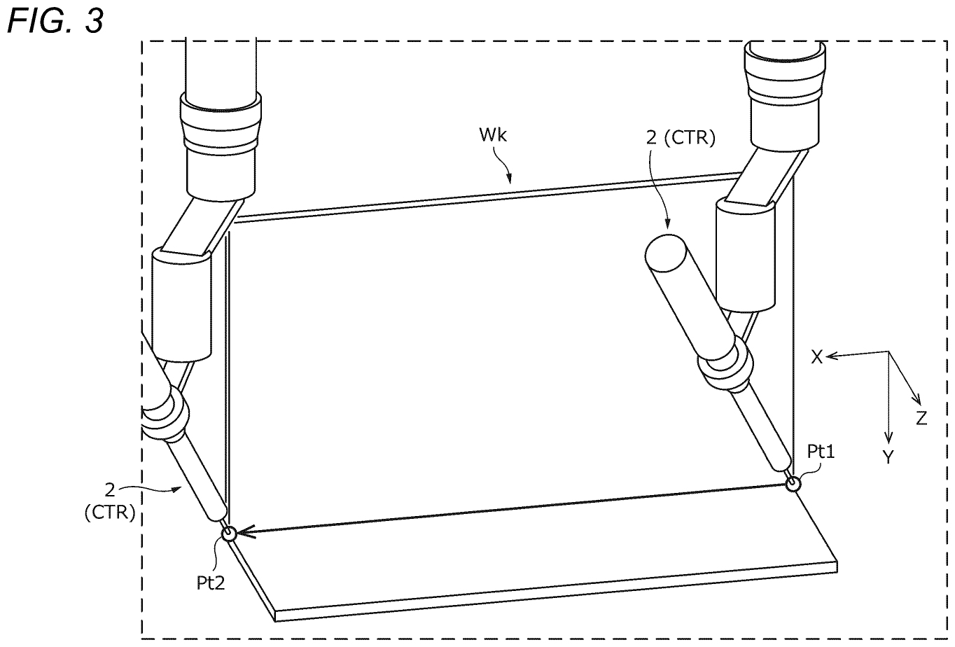

Next, a teaching screen displayed when teaching a teaching point and a teaching example of a linear welding line will be described with reference to FIGS. 2 and 3. FIG. 2 shows an example of the teaching screen. FIG. 3 shows a welding teaching example of a linear welding line WL1.

The following teaching screens shown in FIGS. 2 to 7 are images generated by the processor 11 and displayed on the display unit 14 when the generation of the welding teaching program is executed. It should be noted that the teaching image may be displayed on the head-mounted display HMD and the like other than the display unit 14. The operator operates the controller CTR to perform teaching work on the welding robot 1 while viewing the teaching image. It should be noted that the following teaching screens shown in FIGS. 2 to 7 are merely examples and the present disclosure is not limited thereto. For example, the teaching screen may include, in addition to the workpiece Wk and the welding torch 2, production facilities such as a jig, a positioner or a fixing base of the workpiece Wk, and the welding robot 1.

In the description of FIG. 2, in order to make the description easy to understand, two teaching points to be taught are referred to as a welding start point Pt1 and a welding end point Pt2, respectively, so that it can be understood whether each teaching point indicates the start position or the end position of the welding. However, each teaching point in actual operation may be simply processed as information indicating position information and posture information to be taught without including information indicating whether the teaching point to be taught is the start position or the end position of welding.

The teaching screen is generated to include the workpiece Wk to be welded and the welding torch 2. The welding torch 2 on the teaching screen is reflected on the teaching screen in a position and a posture reflecting the position and the posture of the controller CTR gripped and operated by the operator. It should be noted that although the welding line WL corresponding to the workpiece Wk is shown in FIG. 2 for easy understanding of the description, it is needless to say that the display may be omitted on the teaching screen.

The operator operates the controller CTR to teach a teaching point (hereinafter, referred to as the “welding start point”) indicating a start position of welding on the actual workpiece Wk and a teaching point (hereinafter, referred to as the “welding end point”) indicating an end position of welding on the workpiece Wk.

The operator presses the operation button (not shown) in a state where the distal end of the controller CTR is brought into contact with the position of the welding start point Pt1 of the welding line WL1 on the actual workpiece Wk. The controller CTR calculates position information of the distal end of the controller CTR at a pressing timing of the operation button (not shown) as the position information of the controller CTR at the welding start point Pt1, and calculates posture information of the controller CTR at the pressing timing of the operation button (not shown) as the posture information of the welding torch 2 at the welding start point Pt1. The controller CTR transmits the calculated position information of the controller CTR and the calculated posture information of the controller CTR to the terminal device P1 in association with each other.

The operator presses the operation button (not shown) in a state where the distal end of the controller CTR is brought into contact with the position of the welding end point Pt2 of the welding line WL1 on the actual workpiece Wk. The controller CTR calculates position information of the distal end of the controller CTR at a pressing timing of the operation button (not shown) as the position information of the controller CTR at the welding end point Pt2, and calculates posture information of the controller CTR at the pressing timing of the operation button (not shown) as the posture information of the welding torch 2 at the welding end point Pt2. The controller CTR transmits the calculated position information of the controller CTR and the calculated posture information of the controller CTR to the terminal device P1 in association with each other.

Based on the position information and the posture information of each of the welding start point Pt1 and the welding end point Pt2 transmitted from the controller CTR, the processor 11 of the terminal device P1 calculates a reference coordinate system (XYZ coordinate system) that is a reference of posture information (a tilt angle, a forward and backward angle, and a twisting angle) of each teaching point used to generate the welding operation program. Here, a calculation method of the reference coordinate system when the welding line WL1 is linear will be described.

### <Calculation Method 1 of Reference Coordinate System>

First, an X-axis in the reference coordinate system is calculated to be along a line segment (that is, the welding line WL1) connecting a position of the welding start point Pt1 and a position of the welding end point Pt2. An X direction is equal to a direction passing through each teaching point in a teaching order, that is, a direction from the welding start point Pt1 to the welding end point Pt2.

A Z-axis in the reference coordinate system is an axis orthogonal to the X direction, and is calculated along a surface of a target workpiece Wk1 constituting the workpiece Wk produced by welding based on production data of the workpiece Wk. A Z direction is set along a direction away from the welding line WL1 on the Z-axis.

A Y-axis in the reference coordinate system is an axis orthogonal to each of the X-axis and the Z-axis, and is obtained as an outer product of the X-axis and the Z-axis.

The processor 11 executes correction processing of the posture information of each of the welding start point Pt1 and the welding end point Pt2 based on the calculated reference coordinate system. The processor 11 registers the position information of each of the welding start point Pt1 and the welding end point Pt2 and the corrected posture information, generates a welding teaching program for welding the welding line WL1, and transmits the welding teaching program to the robot control device 3.

Hereinafter, correction processing of each of the tilt angle, the forward and backward angle, and the twisting angle, which are included in the posture information, will be described.

### <Tilt Angle Correction Processing>

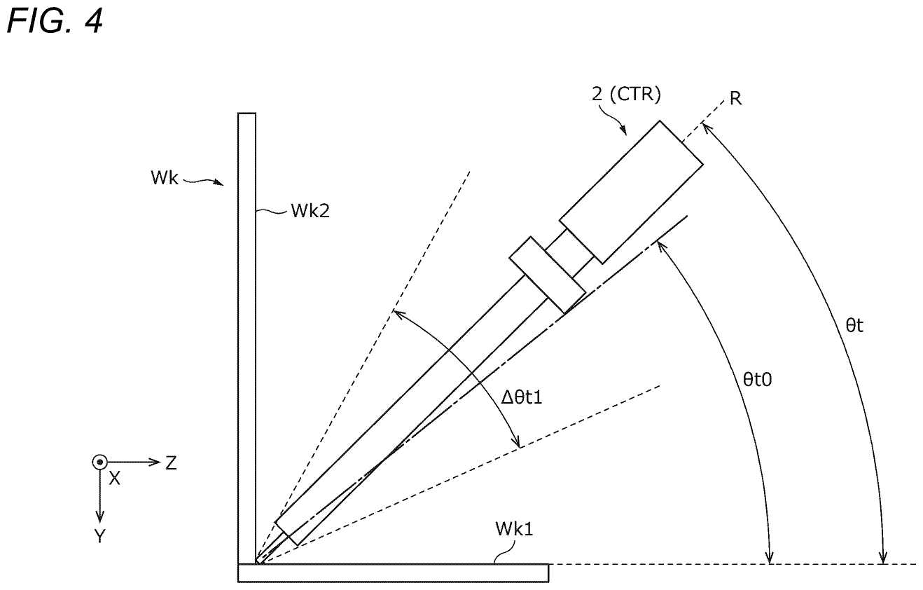

A tilt angle θt and a correction processing example of the tilt angle θt will be described with reference to FIG. 4. FIG. 4 illustrates a correction example of the tilt angle. It should be noted that the tilt angle θt, an allowable range Δθt1, and an optimal posture θt0 shown in FIG. 4 are merely examples, and the present disclosure is not limited thereto.

The tilt angle θt is an angle between a center line R passing through an electrode center of the welding torch 2 and the surface of the target workpiece Wk1, centered on the X-axis, in a Y-Z plane. It should be noted that the tilt angle θt shown in FIG. 4 is set by setting the surface of the target workpiece Wk1 along the Z-axis as a reference angle of the tilt angle θt=0° (zero).

When the operator wants to correct the tilt angle θt, the operator sets the allowable range Δθt1 of the tilt angle and an optimal posture θt0, which is a corrected tilt angle, in advance as conditions for correcting the tilt angle θt. The terminal device P1 stores (registers) the allowable range Δθt1 and the optimal posture θt0 in the memory 12 in association with each other.

The processor 11 calculates the tilt angle θt of the taught teaching point based on the posture information of the controller CTR at the teaching point transmitted from the controller CTR and the calculated reference coordinate system. When the allowable range Δθt1 and the optimal posture θt0 of the tilt angle θt are set by the operator in advance, the processor 11 determines whether the calculated tilt angle θt is included in the allowable range Δθt1.

When it is determined that the calculated tilt angle θt is included in the allowable range Δθt1, the processor 11 executes the correction processing of correcting the tilt angle θt to the optimal posture θt0. On the other hand, when it is determined that the calculated tilt angle θt is not included in the allowable range Δθt1, the processor 11 omits the correction processing of the tilt angle θt.

For example, when the allowable range of the tilt angle is set to 5° and the optimal posture is set to 45°, the processor 11 determines whether the acquired tilt angle of the teaching point is included in the allowable range (=40° to 50°) for the optimal posture (=45°). When the tilt angle of the teaching point is 42°, the processor 11 determines that the tilt angle of the teaching point is included in the allowable range, and executes correction for setting the tilt angle (=42°) of the teaching point to the optimal posture (=45°) set in advance. On the other hand, when the tilt angle of the teaching point is 38.5°, the processor 11 determines that the tilt angle of the teaching point is not included in the allowable range, and omits the correction of the tilt angle of the teaching point.

It should be noted that in the present disclosure, an example in which the optimal posture of the tilt angle is set as an angle is shown, but the optimal posture may be set as a ratio to an angle between the target workpiece Wk1 and the target workpiece Wk2 at which the welding line WL1 is set (here, an interior angle between the target workpiece Wk1 and the target workpiece Wk2). The optimal posture of the tilt angle is set to, for example, 50%. In such a case, the optimal posture of the tilt angle is set to 45° when the angle formed by the target workpiece Wk1 and the target workpiece Wk2 is 90°, and is set to 30° when the angle formed by the target workpiece Wk1 and the target workpiece Wk2 is 60°.

### <Forward and Backward Angle Correction Processing>

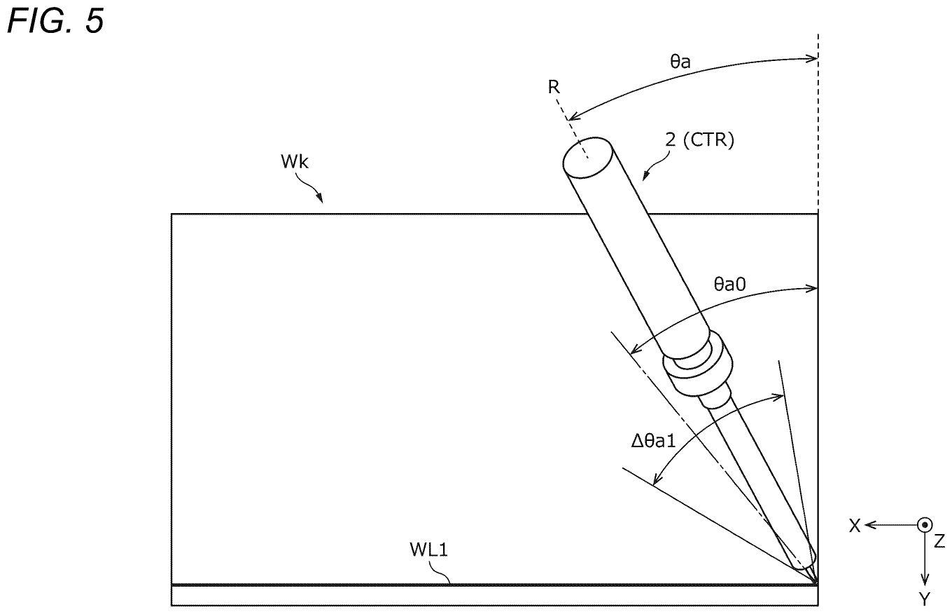

A forward and backward angle θa and a correction processing example of the forward and backward angle θa will be described with reference to FIG. 5. FIG. 5 illustrates a correction example of the forward and backward angle θa. It should be noted that the forward and backward angle θa, an allowable range Δθa1, and an optimal posture θa0 illustrated in FIG. 5 are merely examples, and the present disclosure is not limited thereto.

The forward and backward angle θa is an angle formed by the center line R of the welding torch 2 and a direction (here, a direction opposite to the Y direction) orthogonal to a welding direction and along a surface of the target workpiece Wk2 in an X-Y plane. It should be noted that the forward and backward angle θa shown in FIG. 5 is set by setting a direction along the surface of the target workpiece Wk2 as a reference angle of the forward and backward angle θa=0° (zero).

When the operator wants to correct the forward and backward angle θa, the operator sets the allowable range Δθa1 of the forward and backward angle and the optimal posture θa0, which is a corrected forward and backward angle, in advance as conditions for correcting the forward and backward angle θa. The terminal device P1 stores (registers) the allowable range Δθa1 and the optimal posture θa0 in the memory 12 in association with each other.

The processor 11 calculates the forward and backward angle θa of the taught teaching point based on the posture information of the controller CTR at the teaching point transmitted from the controller CTR and the calculated reference coordinate system. When the allowable range Δθa1 and the optimal posture θa0 of the forward and backward angle θa are set by the operator in advance, the processor 11 determines whether the calculated forward and backward angle θa is included in the allowable range Δθa1.

When it is determined that the calculated forward and backward angle θa is included in the allowable range Δθa1, the processor 11 executes the correction processing of correcting the forward and backward angle θa to the optimal posture θa0. On the other hand, when it is determined that the calculated forward and backward angle θa is not included in the allowable range Δθa1, the processor 11 omits the correction processing of the forward and backward angle θa.

For example, when the allowable range of the forward and backward angle is set to 7.5° and the optimal posture is set to 55°, the processor 11 determines whether the acquired forward and backward angle of the teaching point is included in the allowable range (=47.5° to 62.5°) for the optimal posture (=55°). When the forward and backward angle of the teaching point is 58°, the processor 11 determines that the forward and backward angle of the teaching point is included in the allowable range, and executes correction for setting the forward and backward angle (=58°) of the teaching point to the optimal posture (=55°) set in advance. On the other hand, when the forward and backward angle of the teaching point is 45°, the processor 11 determines that the forward and backward angle of the teaching point is not included in the allowable range, and omits the correction of the forward and backward angle of the teaching point.

### <Twisting Angle Correction Processing>

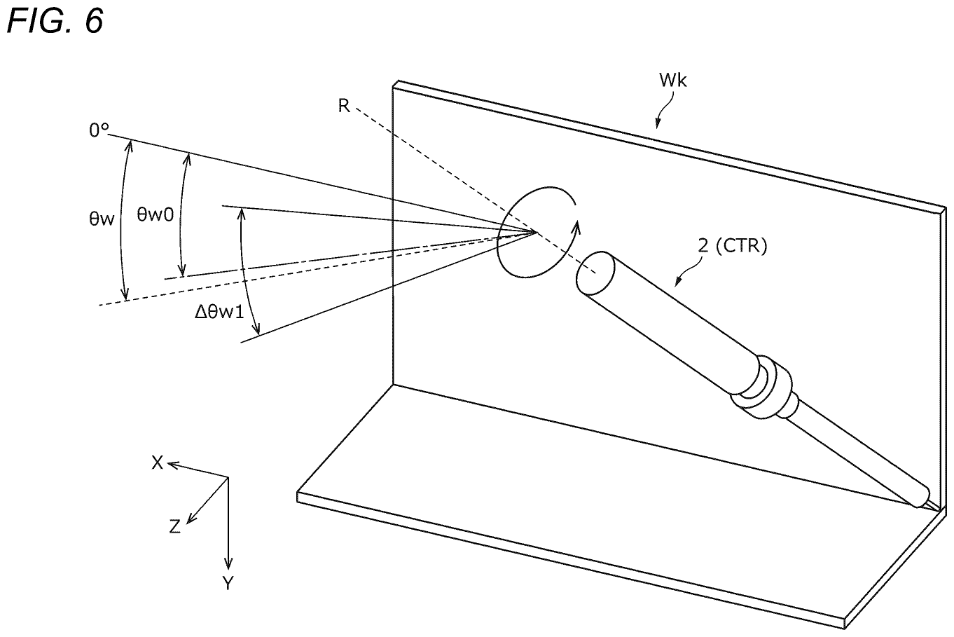

A twisting angle θw and a correction processing example of the twisting angle θw will be described with reference to FIG. 6. FIG. 6 illustrates a correction example of the twisting angle θw. It should be noted that the twisting angle θw, an allowable range Δθw1, and an optimal posture θw0 shown in FIG. 6 are merely examples, and the present disclosure is not limited thereto.

The twisting angle θw is an angle about the center line R of the welding torch 2. It should be noted that a reference angle (=0° (zero)) of the twisting angle θw shown in FIG. 6 is merely an example, and the present disclosure is not limited thereto.

When the operator wants to correct the twisting angle θw, the operator sets the allowable range Δθw1 of the twisting angle and the optimal posture θw0, which is a corrected twisting angle, in advance as conditions for correcting the twisting angle θw. The terminal device P1 stores (registers) the allowable range Δθw1 and the optimal posture θw0 in the memory 12 in association with each other.

The processor 11 calculates the twisting angle θw of the taught teaching point based on the posture information of the controller CTR at the teaching point transmitted from the controller CTR and the calculated reference coordinate system. When the allowable range Δθw1 and the optimal posture θw0 of the twisting angle θw are set by the operator in advance, the processor 11 determines whether the calculated twisting angle θw is included in the allowable range Δθw1.

When it is determined that the calculated twisting angle θw is included in the allowable range Δθw1, the processor 11 executes the correction processing of correcting the twisting angle θw to the optimal posture θw0. On the other hand, when it is determined that the calculated twisting angle θw is not included in the allowable range Δθw1, the processor 11 omits the correction processing of the twisting angle θw.

For example, when the allowable range of the twisting angle is set to 10° and the optimal posture is set to 30°, the processor 11 determines whether the acquired twisting angle of the teaching point is included in the allowable range (=20° to 40°) for the optimal posture (=30°). When the twisting angle of the teaching point is 58°, the processor 11 determines that the twisting angle of the teaching point is included in the allowable range, and executes correction for setting the twisting angle (=25°) of the teaching point to the optimal posture (=30°) set in advance. On the other hand, when the twisting angle of the teaching point is 15°, the processor 11 determines that the twisting angle of the teaching point is not included in the allowable range, and omits the correction of the twisting angle of the teaching point.

### <Teaching Example of Curved Welding Line>

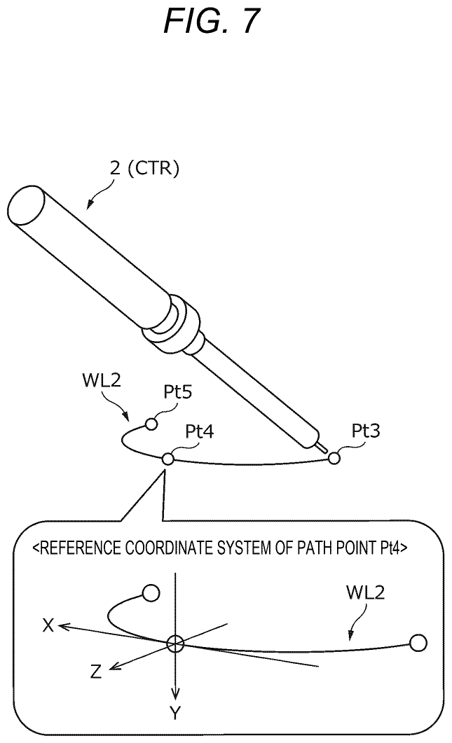

Next, a teaching example in a case of welding a curved welding line will be described with reference to FIG. 7. FIG. 7 shows a welding teaching example of a curved welding line WL2. It should be noted that in FIG. 7, the workpiece is not shown in order to make positions of teaching points and a curve connecting the teaching points (that is, the welding line WL2) easy to see. In FIG. 7, in order to make the description of the reference coordinate system easy to understand, only the reference coordinate system corresponding to a path point Pt4 is shown, and the reference coordinate systems corresponding to a welding start point Pt3 and a welding end point Pt5 are not shown.

It should be noted that in the description of FIG. 7, in order to make the description easy to understand, three teaching points to be taught are referred to as the welding start point Pt3, the path point Pt4, and the welding end point Pt5, respectively, so that it can be understood whether each teaching point indicates the start position, the path point, and the end position of the welding. However, each teaching point in actual operation may be simply processed as information indicating position information and posture information to be taught without including information indicating whether the teaching point to be taught is the start position, the middle position, or the end position of welding.

The operator operates the controller CTR to teach the welding start point Pt3, the path point Pt4 indicating a position of a welding path between the welding start point Pt3 and the welding end point Pt5, and the welding end point Pt5 for an actual workpiece (not shown).

The operator presses the operation button (not shown) in a state where the distal end of the controller CTR is brought into contact with the position of the welding start point Pt3 of the welding line WL2 on the actual workpiece Wk. The controller CTR calculates position information of the distal end of the controller CTR at a pressing timing of the operation button (not shown) as the position information of the controller CTR at the welding start point Pt3, and calculates posture information of the controller CTR at the pressing timing of the operation button (not shown) as the posture information of the welding torch 2 at the welding start point Pt3, and then transmits the position information and the posture information to the terminal device P1.

The operator presses the operation button (not shown) in a state where the distal end of the controller CTR is brought into contact with the position of the path point Pt4 of the welding line WL2 on the actual workpiece Wk. The controller CTR calculates position information of the distal end of the controller CTR at a pressing timing of the operation button (not shown) as the position information of the controller CTR at the path point Pt4, and calculates posture information of the controller CTR at the pressing timing of the operation button (not shown) as the posture information of the welding torch 2 at the path point Pt4, and then transmits the position information and the posture information to the terminal device P1.

The operator presses the operation button (not shown) in a state where the distal end of the controller CTR is brought into contact with the position of the welding end point Pt5 of the welding line WL2 on the actual workpiece Wk. The controller CTR calculates position information of the distal end of the controller CTR at a pressing timing of the operation button (not shown) as the position information of the controller CTR at the welding end point Pt5, and calculates posture information of the controller CTR at the pressing timing of the operation button (not shown) as the posture information of the welding torch 2 at the welding end point Pt5, and then transmits the position information and the posture information to the terminal device P1.

Based on the position information and the posture information of each of the welding start point Pt3, the path point Pt4, and the welding end point Pt5 transmitted from the controller CTR, the processor 11 of the terminal device P1 calculates a reference coordinate system (XYZ coordinate system) that is a reference of posture information (a tilt angle, a forward and backward angle, and a twisting angle) of each teaching point used to generate the welding operation program. Here, a calculation method of the reference coordinate system at each teaching point when the welding line WL2 is curved has been described.

### <Calculation Method 2 of Reference Coordinate System>

First, in calculation of a reference coordinate system, the processor 11 calculates an arc (welding line WL2) passing through each of the welding start point Pt3, the path point Pt4, and the welding end point Pt5. The processor 11 calculates the reference coordinate system which is a reference of the posture information of each teaching point based on the arc (welding line WL2) and the position information and the posture information of each teaching point (each of the welding start point Pt3, the path point Pt4, and the welding end point Pt5).

An X-axis in the reference coordinate system is a tangent at the teaching point (welding start point Pt3, path point Pt4, or welding end point Pt5) on the arc (welding line WL2). An X direction indicates a direction passing through each teaching point in a teaching order, that is, a welding direction of the welding line WL2.

A Z-axis in the reference coordinate system is an axis orthogonal to the X direction, and is calculated along a surface of a target workpiece (not shown) constituting a workpiece (not shown) produced by welding based on production data of the workpiece (not shown). A Z direction is set along a direction away from the arc (welding line WL2) on the Z-axis.

A Y-axis in the reference coordinate system is an axis orthogonal to each of the X-axis and the Z-axis, and is obtained as an outer product of the X-axis and the Z-axis.

The processor 11 executes correction processing of the posture information of the welding start point Pt3 based on the calculated reference coordinate system corresponding to the welding start point Pt3, executes correction processing of the posture information of the path point Pt4 based on the calculated reference coordinate system corresponding to the path point Pt4, and executes correction processing of the posture information of the welding end point Pt5 based on the calculated reference coordinate system corresponding to the welding end point Pt5. The processor 11 registers the position information and the corrected posture information of each teaching point (each of the welding start point Pt3, the path point Pt4, and the welding end point Pt5), generates a welding teaching program for welding the welding line WL2, and transmits the welding teaching program to the robot control device 3.

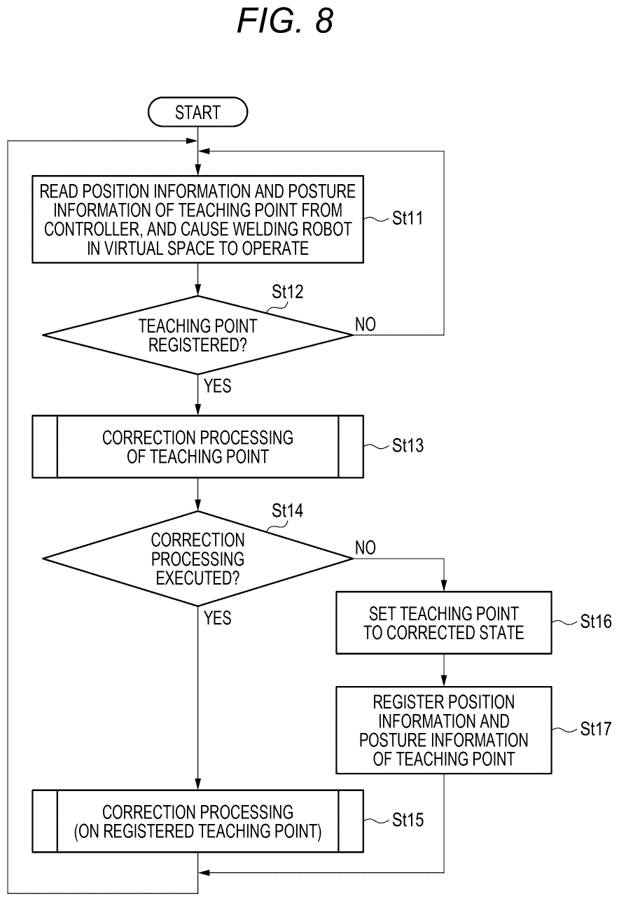

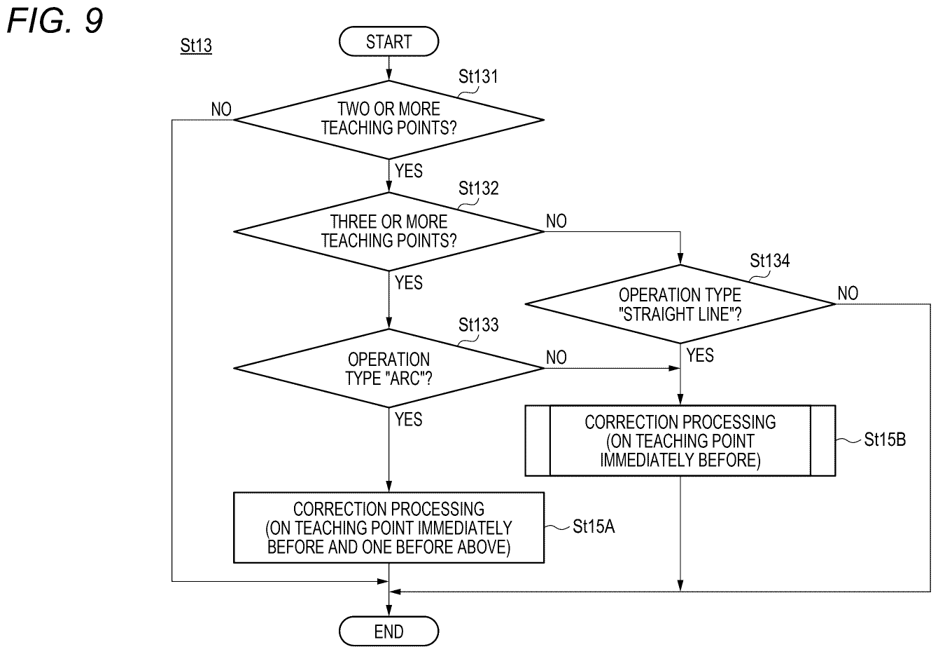

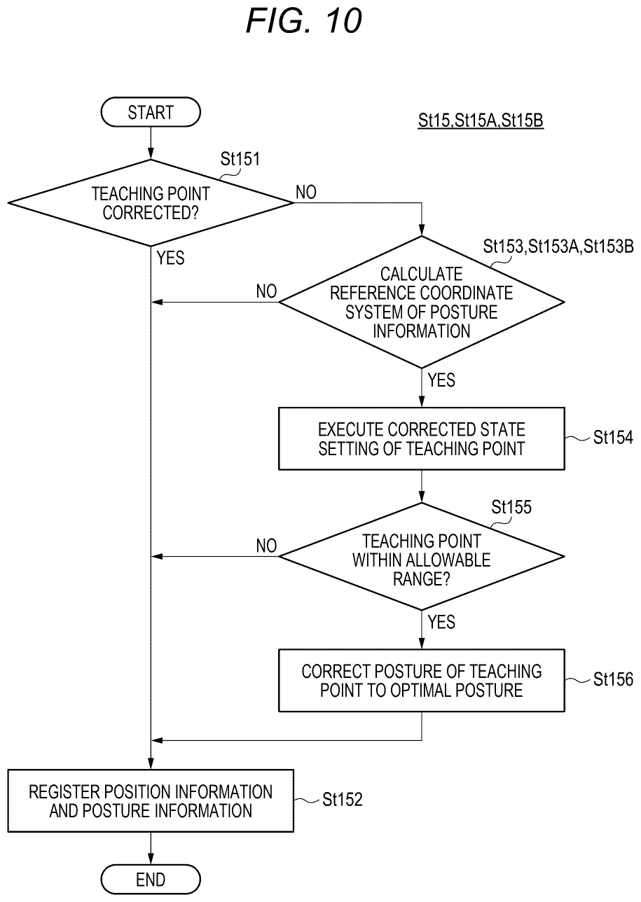

Next, an operation procedure example of the terminal device P1 according to the embodiment will be described with reference to FIGS. 8 to 10. FIG. 8 is a flowchart showing an operation procedure example of the terminal device P1 in the embodiment, and FIG. 9 is a flowchart showing a correction procedure example of the teaching point of the terminal device P1 in the embodiment. FIG. 10 is a flowchart showing a correction procedure example of the teaching point of the terminal device P1 according to the embodiment.

The processor 11 acquires and reads the position information and the posture information of the teaching point transmitted from the controller CTR, and operates the welding robot 1 (the welding torch 2 in FIGS. 2 to 7) constructed in a virtual space shown by the teaching screen based on the position information and the posture information of the teaching point (St11).

The processor 11 receives an operation of whether to register the acquired teaching point from the operator, and determines whether the registration of the teaching point is instructed based on the received operation (St12).

If it is determined in step St12 that the registration of the teaching point is instructed (St12, YES), the processor 11 executes correction processing on the teaching point (St13).

On the other hand, if it is determined in step St12 that the registration of the teaching point is not instructed (St12, NO), the processor 11 returns to the processing of step St11.

The processor 11 determines whether the number of currently registered teaching points is two or more (St131).

If it is determined in the processing of step St131 that the number of currently registered teaching points is two or more (St131, YES), the processor 11 further determines whether the number of currently registered teaching points is three or more (St132).

On the other hand, if it is determined in the processing of step St131 that the number of currently registered teaching points is not two or more (St131, NO), the processor 11 ends the correction processing (step St13) for this teaching point and proceeds to step St14.

In the processing of step St132, if it is determined that the number of currently registered teaching points is three or more (St132, YES), the processor 11 receives an input (selection) operation of a welding operation type to the input unit 13 by the operator, and determines whether the welding operation type taught by the current teaching is “arc” (St133).

It should be noted that the welding operation type here designates whether to generate a welding teaching program for welding an arc-shaped or linear welding line in the generation of the welding teaching program by the processor 11. The processor 11 generates a welding teaching program for welding an arc-shaped welding line when the designated welding operation type is “arc”, and generates a welding teaching program for welding a linear welding line when the designated welding operation type is “straight line”.

If it is determined in the processing of step St133 that the designated welding operation type is “arc” (St133, YES), the processor 11 reads the teaching point registered immediately before and the teaching point registered before the above-mentioned one, and executes the correction processing on each of these two teaching points (St15A).

On the other hand, if it is determined in the processing of step St133 that the designated welding operation type is not the “arc” (St133, NO), the processor 11 reads the teaching point registered immediately before and executes the correction processing (St15B).

On the other hand, if it is determined in the processing of step St132 that the number of currently registered teaching points is not three or more (St132, NO), the processor 11 receives an input (selection) operation of the welding operation type to the input unit 13 by the operator, and determines whether the welding operation type taught by the current teaching is “straight line” (St134).

If it is determined in the processing of step St134 that the designated welding operation type is “straight line” (St134, YES), the processor 11 reads the teaching point registered immediately before and executes the correction processing (St15B).

On the other hand, if it is determined in the processing of step St134 that the designated welding operation type is not the “straight line” (St134, NO), the processor 11 ends the correction processing (step St13) for the teaching point and proceeds to step St14.

The processor 11 determines whether the correction processing of the teaching point is executed in the processing of step St13 (St14).

If it is determined in step St14 that the correction processing of the teaching point is executed in the processing of step St13 (St14, YES), the processor 11 executes the correction processing for the registered teaching point as generation of the welding teaching program (St15).

The processor 11 determines whether the teaching point registered in the processing of step St12 is corrected (St151).

If it is determined in the processing of step St151 that the teaching point is corrected (St151, YES), the processor 11 stores (registers) the position information and the posture information of the corrected teaching point in the memory 12 (St152).

On the other hand, if it is determined in the processing of step St151 that the teaching point is not corrected (St151, NO), the processor 11 determines whether to calculate the reference coordinate system of the posture information (that is, the tilt angle, the forward and backward angle, and the twisting angle) of the teaching point (St153, St153A, St153B).

Specifically, if the execution of the correction processing is determined in the processing of step St14 (St14, YES), since the number of registered teaching points is 0 (zero), the processor 11 determines not to calculate the reference coordinate system (St153, NO), and stores (registers) the position information and the posture information of the current teaching point in the memory 12 (St152).

If the operation type is the “arc” and the execution of the correction processing is determined in the processing of step St133 (St133, YES), the processor 11 determines to calculate the reference coordinate system (St153A, YES), and calculates the reference coordinate system of the posture information (that is, the tilt angle, the forward and backward angle, and the twisting angle) at each teaching point based on the position information of the latest teaching point and the position information of each of the registered two teaching points. The processor 11 executes corrected state setting of setting a state of each of the three teaching points to a corrected state (St154).

If the operation type is not the “arc” in the processing of step St133 or the operation type is the “straight line” in the processing of step St134 and the execution of the correction processing is determined (St133 or St134, YES), the processor 11 determines to calculate the reference coordinate system (St153, YES), and calculates the reference coordinate system of the posture information (that is, the tilt angle, the forward and backward angle, and the twisting angle) at the teaching points based on the position information of the latest teaching point and the position information of the teaching point registered immediately before. The processor 11 executes the corrected state setting of setting a state of each of the two teaching points to a corrected state (St154).

The processor 11 determines whether the posture information of each teaching point is within an allowable range of the posture information set by the operator in advance (St155). It should be noted that the processing of step St155 is executed only for parameters (the tilt angle, the forward and backward angle, or the twisting angle) for which an allowable range is set in advance, and is omitted for parameters (the tilt angle, the forward and backward angle, or the twisting angle) for which no allowable range is set in advance.

If it is determined in the processing of step St155 that a parameter indicated by the posture information of the teaching point, for which an allowable range is set in advance, is within the allowable range (St155, YES), the processor 11 corrects the posture information of the teaching point to an optimal posture of the posture information set by the operator in advance (St156).

If it is determined in the processing of step St155 that a parameter indicated by the posture information of the teaching point, for which an allowable range is set in advance, is not within the allowable range (St155, NO), the processor 11 omits the correction of the posture information of the teaching point.

The processor 11 stores (registers) the position information and the posture information of each teaching point in the memory 12 (St152) after the correction necessity determination (step St155) and the correction processing (step St156) of each of the tilt angle, the forward and backward angle, and the twisting angle of each teaching point are completed for the parameters for which allowable ranges are set in advance.

On the other hand, if it is determined in step St14 that the correction processing of the teaching point is not executed in the processing of step St13 (St14, NO), the processor 11 sets the teaching point to the corrected state (St16), and registers the position information and the posture information of the teaching point (St17).

When it is determined that the teaching of the teaching points used to generate the welding teaching program is completed by the above operation procedure, the processor 11 generates the welding teaching program based on the position information and the posture information of each of the two or three taught teaching points. It should be noted that the processor 11 may determine the completion of teaching of the teaching points based on an operation by the operator via the input unit 13 of the terminal device P1. The processor 11 may determine the completion of teaching the teaching points based on whether the operation type set in advance or designated or selected in step St13 is “arc” or “straight line” and the number of registered teaching points.

As described above, the terminal device P1 in the embodiment can acquire the posture information of the welding torch 2 suitable for the welding operation executed by the welding robot 1 by correcting the posture information of the controller CTR at the teaching point based on the setting of the allowable range and the optimal posture with respect to the posture information. Accordingly, the terminal device P1 can more efficiently generate the welding operation program by using the position information of the teaching point and the corrected posture information of the teaching point. Therefore, since the terminal device P1 can generate the welding operation program in which the posture information of the teaching point is corrected to a posture (optimal posture) suitable for the welding operation, it is possible to support the generation operation of the welding teaching program by the operator by eliminating or more effectively reducing the labor of correction operation of the welding teaching program by the operator.

### APPENDIX

The following techniques are disclosed based on the above description of the embodiments.

### (Technique 1)

A welding teaching system 200, including:
a teaching device (controller CTR) that is operated by an operator and receives a teaching operation for teaching an operation of a welding torch 2 provided in a welding robot 1; and
a terminal device P1 capable of communicating with the teaching device (controller CTR), in which
the teaching device (controller CTR) is configured to
   acquire, from the teaching operation by the operator, a teaching point including a teaching position for teaching a position of the welding torch 2 that performs welding and a teaching posture (that is, tilt angle θt, forward and backward angle θa, and twisting angle θw) for teaching a posture of the welding torch 2, and transmit the teaching point to the terminal device P1, and
the terminal device P1 is configured to
   calculate, based on the teaching position of each of a plurality of the acquired teaching points and information related to a workpiece Wk subjected to the welding, a reference coordinate system related to the posture of the welding torch 2 at the teaching position,
   correct the teaching posture to a set posture (optimal posture) set in advance when determining that correction for the teaching posture is necessary based on the teaching posture with respect to the reference coordinate system, and
   generate and output a welding teaching program of the welding robot 1 for welding the workpiece Wk based on the teaching position and the teaching posture of each of the plurality of teaching points.

With this configuration, when it is determined that the taught posture is not a posture suitable for an actual welding operation executed by the welding robot 1, the welding teaching system 200 corrects the taught posture to an optimal posture set in advance, thereby more efficiently generating a welding operation program taught in a posture suitable for the actual welding operation. As a result, the welding teaching system 200 can support the generation operation of the welding teaching program by the operator by eliminating or more effectively reducing the work required for the correction operation of the posture of each teaching point or the correction operation of the welding teaching program after the teaching by the operator.

### (Technique 2)

The welding teaching system according to (Technique 1), in which
the terminal device P1 is configured to correct the posture to the set posture (optimal posture) when determining that the teaching posture (that is, tilt angle θt, forward and backward angle θa, and twisting angle θw) is within a predetermined range (allowable range) of the set posture (optimal posture).

With this configuration, when it is determined that the taught posture is not a posture suitable for an actual welding operation executed by the welding robot 1, and is within the allowable range Δθa1, Δθt1, or Δθw1 for correcting the taught posture, the welding teaching system 200 corrects the taught posture to an optimal posture set in advance, thereby more efficiently generating a welding operation program taught in a posture suitable for the actual welding operation.

### (Technique 3)

The welding teaching system according to (Technique 1) or (Technique 2), in which
the terminal device P1 is configured to
   acquire information indicating whether an operation trajectory of the welding torch 2 in the welding is linear or arc-shaped, and
   when the operation trajectory of the welding torch 2 in the welding is linear, calculate the reference coordinate system based on the teaching positions of two teaching points and the information related to the workpiece Wk, and determine whether the correction for the teaching posture of each of the teaching points based on the calculated reference coordinate system is necessary.

With this configuration, when the welding line to be welded by the welding operation program generated by teaching is linear, the welding teaching system 200 can more efficiently generate the welding operation program by acquiring at least two teaching points necessary for generating the welding operation program.

### (Technique 4)

The welding teaching system according to (Technique 1) or (Technique 2), in which
the terminal device P1 is configured to
   acquire information indicating whether an operation trajectory of the welding torch 2 in the welding is linear or arc-shaped,
   acquire three teaching points when the operation trajectory of the welding torch 2 in the welding is arc-shaped, and
   for each of the teaching points, calculate the reference coordinate system at the teaching position based on the three teaching points and the information related to the workpiece Wk, and determine whether the correction for the teaching posture of the teaching point corresponding to the calculated reference coordinate system is necessary.

With this configuration, when the welding line to be welded by the welding operation program generated by teaching is arc-shaped, the welding teaching system 200 can more efficiently generate the welding operation program by acquiring at least three teaching points necessary for generating the welding operation program.

### (Technique 5)

The welding teaching system according to any one of (Technique 1) to (Technique 4), in which
the teaching posture includes a tilt angle θt, a forward and backward angle θa, and a twisting angle θw of the welding torch 2.

With this configuration, the welding teaching system 200 can determine whether each of the taught postures (the tilt angle θt, the forward and backward angle θa, and the twisting angle θw) is a posture suitable for the actual welding operation executed by the welding robot 1, and therefore can more efficiently generate the welding operation program taught in the posture suitable for the actual welding operation. As a result, the welding teaching system 200 can support the generation operation of the welding teaching program by the operator by eliminating or more effectively reducing the work required for the correction operation of the posture of each teaching point or the correction operation of the welding teaching program after the teaching by the operator.

### (Technique 6)

The welding teaching system according to (Technique 5), in which
the set posture (optimal posture) is set to at least one of the tilt angle, the forward and backward angle, and the twisting angle of the welding torch 2.

With this configuration, when only an angle (that is, the tilt angle θt, the forward and backward angle θa, or the twisting angle θw) among the taught postures (the tilt angle θt, the forward and backward angle θa, and the twisting angle θw) needs to be corrected to the posture suitable for the actual welding operation executed by the welding robot 1, the welding teaching system 200 can more efficiently generate the welding operation program taught in the posture suitable for the actual welding operation by correcting only the angle for which the optimal posture is set in advance. As a result, the welding teaching system 200 can support the generation operation of the welding teaching program by the operator by eliminating or more effectively reducing the work required for the correction operation of the posture of each teaching point or the correction operation of the welding teaching program after the teaching by the operator.

### (Technique 7)

A generation method for a welding program to be performed by a system (welding teaching system 200) including a teaching device (controller CTR) that is operated by an operator and receives a teaching operation for teaching an operation of a welding torch 2 provided in a welding robot 1, and a terminal device P1 capable of communicating with the teaching device (controller CTR), the generation method for the welding program including:
acquiring, from the teaching operation by the operator, a teaching point including a teaching position for teaching a position of the welding torch 2 that performs welding and a teaching posture (that is, tilt angle θt, forward and backward angle θa, and twisting angle θw) for teaching a posture of the welding torch 2;
calculating, based on the teaching position of each of a plurality of the acquired teaching points and information related to a workpiece Wk subjected to the welding, a reference coordinate system related to the posture of the welding torch 2 at the teaching position;
correcting the teaching posture to a set posture (optimal posture) set in advance when determining that correction for the teaching posture is necessary based on the teaching posture with respect to the reference coordinate system; and
generating and outputting a welding teaching program of the welding robot 1 for welding the workpiece Wk based on the teaching position and the teaching posture of each of the plurality of teaching points.

With this configuration, when it is determined that the taught posture is not a posture suitable for an actual welding operation executed by the welding robot 1, the welding teaching system 200 corrects the taught posture to an optimal posture set in advance, thereby more efficiently generating a welding operation program taught in a posture suitable for the actual welding operation. As a result, the welding teaching system 200 can support the generation operation of the welding teaching program by the operator by eliminating or more effectively reducing the work required for the correction operation of the posture of each teaching point or the correction operation of the welding teaching program after the teaching by the operator.

### (Technique 8)

A non-transitory computer readable medium storing a generation program for a welding program that causes a computer (terminal device P1) to execute a process, the computer being capable of communicating with a teaching device (controller CTR) that is operated by an operator and receives a teaching operation for teaching an operation of a welding torch 2 provided in a welding robot 1, the process including:
a step of acquiring, from the teaching operation by the operator, a teaching point including a teaching position for teaching a position of the welding torch 2 that performs welding and a teaching posture (that is, tilt angle θt, forward and backward angle θa, and twisting angle θw) for teaching a posture of the welding torch 2;
a step of calculating, based on the teaching position of each of a plurality of the acquired teaching points and information related to a workpiece Wk subjected to the welding, a reference coordinate system related to the posture of the welding torch 2 at the teaching position;
a step of correcting the teaching posture to a set posture (optimal posture) set in advance when determining that correction for the teaching posture is necessary based on the teaching posture with respect to the reference coordinate system; and
a step of generating and outputting a welding teaching program of the welding robot 1 for welding the workpiece Wk based on the teaching position and the teaching posture of each of the plurality of teaching points.

With this configuration, when it is determined that the taught posture is not a posture suitable for an actual welding operation executed by the welding robot 1, the terminal device P1 corrects the taught posture to an optimal posture set in advance, thereby more efficiently generating a welding operation program taught in a posture suitable for the actual welding operation. As a result, the terminal device P1 can support the generation operation of the welding teaching program by the operator by eliminating or more effectively reducing the work required for the correction operation of the posture of each teaching point or the correction operation of the welding teaching program after the teaching by the operator.

Although the welding system, the welding robot control program creation device, the welding robot control program creation method, and the welding robot control program creation program according to the present disclosure have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be combined freely in a range without deviating from the spirit of the invention.

The present application is based on Japanese Patent Application No. 2023-194667 filed on Nov. 15, 2023, and the contents of which are incorporated herein by reference.

What is claimed is:

1. A welding teaching system, comprising:
a teaching device that is operated by an operator and receives a teaching operation for teaching an operation of a welding torch provided in a welding robot; and
a terminal device capable of communicating with the teaching device, wherein
the teaching device is configured to:
acquire, from the teaching operation by the operator, a teaching point including a teaching position for teaching a position of the welding torch that performs welding and a teaching posture for teaching a posture of the welding torch, and transmit the teaching point to the terminal device, and
the terminal device is configured to:
calculate, based on the teaching position of each of a plurality of the acquired teaching points and information related to a workpiece subjected to the welding, a reference coordinate system related to the posture of the welding torch at the teaching position;
correct the teaching posture to a set posture set in advance when determining that correction for the teaching posture is necessary based on the teaching posture with respect to the reference coordinate system; and
generate and output a welding teaching program of the welding robot for welding the workpiece based on the teaching position and the teaching posture of each of the plurality of teaching points.

2. The welding teaching system according to claim 1, wherein
the terminal device is configured to correct the posture to the set posture when determining that the teaching posture is within a predetermined range of the set posture.

3. The welding teaching system according to claim 1, wherein
the terminal device is configured to:
acquire information indicating whether an operation trajectory of the welding torch in the welding is linear or arc-shaped; and
when the operation trajectory of the welding torch in the welding is linear, calculate the reference coordinate system based on the teaching position of each of two teaching points and the information related to the workpiece, and determine whether the correction for the teaching posture of each of the teaching points based on the calculated reference coordinate system is necessary.

4. The welding teaching system according to claim 1, wherein
the terminal device is configured to:
acquire information indicating whether an operation trajectory of the welding torch in the welding is linear or arc-shaped;
acquire three teaching points when the operation trajectory of the welding torch in the welding is arc-shaped; and
for each of the teaching points, calculate the reference coordinate system at the teaching position based on the three teaching points and the information related to the workpiece, and determine whether the correction for the teaching posture of the teaching point corresponding to the calculated reference coordinate system is necessary.

5. The welding teaching system according to claim 1, wherein
the teaching posture includes a tilt angle, a forward and backward angle, and a twisting angle of the welding torch.

6. The welding teaching system according to claim 5, wherein
the set posture is set to at least one of the tilt angle, the forward and backward angle, and the twisting angle of the welding torch.

7. A generation method for a welding program to be performed by a system including a teaching device that is operated by an operator and receives a teaching operation for teaching an operation of a welding torch provided in a welding robot, and a terminal device capable of communicating with the teaching device, the generation method for the welding program comprising:
acquiring, from the teaching operation by the operator, a teaching point including a teaching position for teaching a position of the welding torch that performs welding and a teaching posture for teaching a posture of the welding torch;
calculating, based on the teaching position of each of a plurality of the acquired teaching points and information related to a workpiece subjected to the welding, a reference coordinate system related to the posture of the welding torch at the teaching position;
correcting the teaching posture to a set posture set in advance when determining that correction for the teaching posture is necessary based on the teaching posture with respect to the reference coordinate system; and
generating and outputting a welding teaching program of the welding robot for welding the workpiece based on the teaching position and the teaching posture of each of the plurality of teaching points.

8. A non-transitory computer readable medium storing a generation program for a welding program that causes a computer to execute a process, the computer being capable of communicating with a teaching device that is operated by an operator and receives a teaching operation for teaching an operation of a welding torch provided in a welding robot, the process comprising:
a step of acquiring, from the teaching operation by the operator, a teaching point including a teaching position for teaching a position of the welding torch that performs welding and a teaching posture for teaching a posture of the welding torch;
a step of calculating, based on the teaching position of each of a plurality of the acquired teaching points and information related to a workpiece subjected to the welding, a reference coordinate system related to the posture of the welding torch at the teaching position;
a step of correcting the teaching posture to a set posture set in advance when determining that correction for the teaching posture is necessary based on the teaching posture with respect to the reference coordinate system; and
a step of generating and outputting a welding teaching program of the welding robot for welding the workpiece based on the teaching position and the teaching posture of each of the plurality of teaching points.
